(19) United States
(12) Patent Application Publication
(10) Pub. No.: US 2024/0323210 A1
(43) Pub. Date: Sep. 26, 2024

(54) TESTING THE EFFECTIVENESS OF SIGNATURES IN A SIGNATURE-BASED INTRUSION DETECTION SYSTEM (IDS)

(71) Applicant: VMware LLC, Palo Alto, CA (US)

(72) Inventors: Robin Manhas, Santa Clara, CA (US); Nafisa Oanali Mandliwala, Sunnyvale, CA (US); Srinivas Ramaswamy, Dublin, CA (US)

(21) Appl. No.: 18/188,029

(22) Filed: Mar. 22, 2023

(51) Int. Cl. H04L 9/40

(52) U.S. Cl. CPC H04L 63/1425; H04L 63/1416

(57) ABSTRACT

Improved techniques for testing the effectiveness of signatures used by a signature-based intrusion detection system (IDS) are provided. In one set of embodiments, these techniques involve parsing each signature in the IDS's signature set (or a subset of the signature set) to understand the signature's content and creating a synthetic network traffic flow for the signature that mimics/simulates its corresponding attack. The synthetic network traffic flows can then be replayed against the IDS in order to verify that the correct alerts are generated by the IDS.

### BACKGROUND

Unless specifically indicated herein, the approaches described in this section should not be construed as prior art to the claims of the present application and are not admitted as being prior art by inclusion in this section.

An intrusion detection system (IDS) a software and/or hardware-based security solution that monitors the traffic in a computer network for malicious activity (i.e., attacks) and upon detecting such activity, generates alerts for network administrators or other relevant parties. A signature-based IDS is a type of IDS that relies on a set of attack descriptors, known as signatures, to carry out these tasks. In particular, a signature-based IDS attempts to match the signatures in its signature set against monitored network traffic (e.g., packet flows). If a match to a signature is found, the IDS generates an alert indicating that the attack corresponding to the matched signature has been detected.

A typical signature set for a signature-based IDS contains tens of thousands of signatures and is continually updated with new signatures as new attacks are found and analyzed. Accordingly, it is important to have a testing framework in place for the IDS that ensures its signatures are well-defined and do not result in false positive alerts (due to, e.g., signature overlapping). Existing signature-based IDS testing frameworks generally involve collecting datasets of malicious network traffic from real or emulated attack scenarios and replaying the traffic in the datasets against the IDS to check whether alerts are generated. However, for practical reasons, these datasets are often outdated/limited in scope and fail to include malicious traffic data for some subset of signatures, which means this approach cannot comprehensively test the entirety of the signature set.

Further, these datasets often lack attack labels, or in other words data indicating which attacks are present in the dataset traffic and thus which signatures should be matched by the IDS. As a result, the testing framework cannot verify that the IDS has generated the correct alerts in response to a dataset replay; it can only verify that the IDS has generated one or more alerts, without regard to whether those alerts actually map to the specific attacks in the dataset.

### BRIEF DESCRIPTION OF THE DRAWINGS

FIG. 1 depicts an example deployment of a signature-based IDS.

FIG. 2 depicts an IDS test tool according to certain embodiments.

FIG. 3 depicts a signature testing workflow that may be performed by the IDS test tool according to certain embodiments.

FIG. 4 depicts a workflow that may be performed by a signature interpreter of the IDS test tool according to certain embodiments.

FIG. 5 depicts a sample signature according to certain embodiments.

FIG. 6 depicts a sample flow definition file created from the sample signature of FIG. 5 according to certain embodiments.

FIGS. 7A and 7B depict two sample signatures that are dependent on each other according to certain embodiments.

### DETAILED DESCRIPTION

In the following description, for purposes of explanation, numerous examples and details are set forth in order to provide an understanding of various embodiments. It will be evident, however, to one skilled in the art that certain embodiments can be practiced without some of these details or can be practiced with modifications or equivalents thereof.

Embodiments of the present disclosure are directed to improved techniques for testing the effectiveness of signatures used by a signature-based IDS. In one set of embodiments, these techniques involve parsing each signature in the IDS's signature set (or a subset of the signature set) to understand the signature's content and creating a synthetic network traffic flow for the signature that mimics/simulates its corresponding attack. The synthetic network traffic flows can then be replayed against the IDS in order to verify that the correct alerts are generated by the IDS.

### 1. Example IDS Deployment

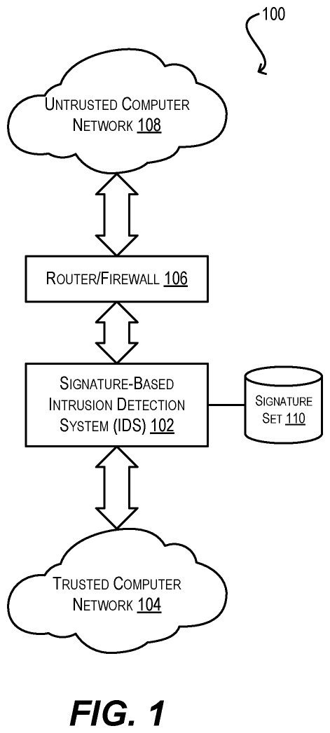

To provide context for the embodiments disclosed herein, FIG. 1 is a simplified block diagram illustrating an example deployment 100 of a signature-based IDS 102. As shown, signature-based IDS 102 is communicatively coupled with a trusted computer network 104 on one side and a router/firewall 106 connected to an untrusted computer network 108 on the other side. For example, trusted computer network 104 may be the private network of an enterprise/organization and untrusted computer network 108 may be a public network such as the Internet. Signature-based IDS 102 can be implemented in software and run on one or more virtual or physical machines or can be implemented partially or entirely in hardware (as, e.g., one or more dedicated devices/systems).

Generally speaking, the goal of signature-based IDS 102 is to prevent unauthorized use or misuse of trusted computer network 104 by monitoring the network traffic flowing into and out of network 104 for malicious activity, referred to herein as attacks, and generating alerts when such attacks are detected. This allows the administrators of trusted computer network 104 to review the alerts and take appropriate remedial actions. Signature-based 1DS 102 achieves this goal by leveraging a repository of signatures (i.e., signature set) 110. Each signature in signature set 110 can be understood as an attack descriptor because it contains a precise, well-defined pattern of the network traffic exhibited by (or in other words, indicative of) a particular attack. In operation, signature-based IDS 102 monitors the network packets traveling into and out of trusted computer network 104 and attempts to match the packet flows against the signatures in signature set 110. If a match is found, signature-based IDS generates an alert for the attack corresponding to the matched signature.

Signature set 110 is typically a monolithic file that is quite large in size (e.g., on the order of thousands of signatures or more). As new attacks are discovered, security researchers analyze and index the attacks using unique attack ID numbers (e.g., CVE database or Microsoft exploit IDs). Third-party signature set vendors then create signatures for these new attacks and update signature set 110 with the newly-created signatures for use by signature-based IDS 102. In some cases, the administrators of trusted computer network 104 may also create and add their own custom signatures to signature set 110 in order to match certain types of traffic flows that are of interest to them.

As mentioned in the Background section, given the large and continually expanding size of signature set 110, it is desirable to employ a framework for testing the signatures included therein. Without such a framework in place, signature set 110 may become bloated over time with signatures that are ineffective in triggering alerts for the attacks they are intended to trigger and/or overlap too closely with other signatures (resulting in false positive alerts).

Existing testing frameworks for signature-based IDSs generally rely on datasets comprising malicious network traffic data obtained from real or emulated attack scenarios, which are replayed against an IDS to determine whether alerts are generated. However, studies have shown that these datasets are prone to being outdated or limited in scope, which means they cannot test every signature in signature set 110. This is particularly true for very recent signatures because it typically takes some time for the datasets to be updated with new attack data. In addition, many of these datasets do not have attack labels for their traffic flows, thereby making it difficult or impossible to verify whether the correct alerts are generated when the datasets are replayed.

### 2. Solution Overview

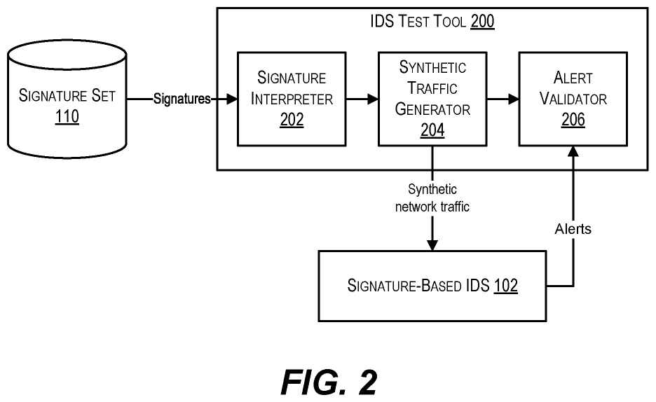

To address the foregoing and other related issues, FIG. 2 depicts a novel IDS test tool 200 for testing the effectiveness of the signatures of signature-based IDS 102 according to certain embodiments. As shown, IDS test tool 200 is communicatively coupled with both signature set 110 and signature-based IDS 102 and includes a signature interpreter 202, a synthetic traffic generator 204, and an alert validator 206. In some embodiments, IDS test tool 200 may be implemented on the same computer system(s)/device(s) as signature-based IDS 102. In other embodiments, IDS test tool 200 may be implemented on a separate computer system/device or group of such systems/devices. Further, IDS test tool 200 may be implemented in software, hardware, or a combination thereof.

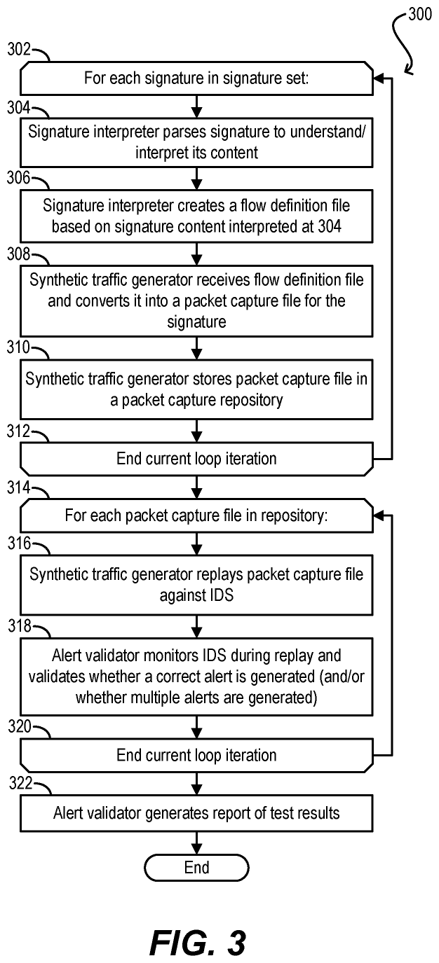

At a high level, IDS test tool 200 improves upon conventional signature-based IDS testing frameworks/methodologies by creating malicious network traffic data from the signature set of the IDS itself, rather than relying on datasets collected by third parties. IDS test tool 200 then replays the self-created network traffic data against the IDS to verify that the correct alerts are raised. FIG. 3 depicts a flowchart 300 of this process according to certain embodiments.

Starting with step 302, TDS test tool 200 can enter a first loop for each signature in signature set 110 (alternatively, IDS test tool 200 can process the signatures in signature set 110 in parallel). Within this first loop, signature interpreter 202 of tool 200 can parse the signature to understand/interpret its content, or in other words identify the network flow(s), matching condition(s) (e.g., content strings and/or regular expressions), trigger action(s) (e.g., alert, drop, etc.), and so on contained within the signature (step 304). In some embodiments, step 304 can include understanding co-relations or dependencies between the signature and other signatures in signature set 110 (described in section (3) below).

At step 306, signature interpreter 202 can create a flow definition file comprising a text-based description of one or more network flows that correspond to the signature content interpreted at step 304. For example, this flow definition file may be formatted/defined using any one of a number of network flow syntax languages known in the art, such as the syntax language used by the open source Flowsynth software. Signature interpreter 202 can then save the file for use by synthetic traffic generator 204 (not shown).

At step 308, synthetic traffic generator 204 can receive the flow definition file for the signature created by signature interpreter 202 and can convert it into a packet capture file that captures (or in other words, includes a recording of) network packet data corresponding to the network flow descriptions in the flow definition file. For example, if the flow definition file describes a network flow F1 including, e.g., the source and destination addresses/ports of F1, the content of the packets in F1, etc., the resulting packet capture file can include data for a series of network packets which conform to F1. In a particular embodiment, synthetic traffic generator 204 can implement this conversion function using Flowsynth and the packet capture file can be a PCAP file that is compatible with the pcap application programming interface (API) used by many common network tools.

At steps 310 and 312, synthetic traffic generator 204 can store the packet capture file in a packet capture repository of IDS test tool 200 and reach the end of the current loop iteration. Steps 302-312 can then be repeated until all of the signatures in signature set 110 are processed.

Upon completion of the first loop (or at some later time), IDS test tool 200 can enter a second loop for each packet capture file in the packet capture repository (step 314). Within this second loop, synthetic traffic generator 204 can replay the packet capture file against signature-based IDS 102, which causes the network packets defined in the packet capture file to be seen as live network traffic by IDS 102 and thus causes IDS 102 to try and match the signatures in signature set 110 against that traffic (step 316). If a match to a particular signature is found, signature-based IDS 102 will generate an alert for the attack corresponding to the matched signature, in accordance with its regular operation.

Concurrently with step 316, alert validator 206 of IDS test tool 200 can monitor signature-based IDS 102 and validate whether the IDS generates a correct alert in response to the replay of the packet capture file, where the “correct” alert is one that corresponds to the signature used to create that file (step 318). In this way, alert validator 206 can verify whether the appropriate signature was matched by signature-based IDS 102. As part of step 318, alert validator 206 can also check whether multiple alerts for the packet capture file are generated, which is indicative of multiple overlapping signatures. Upon completing this validation, alert validator 206 can reach the end of the current loop iteration (step 320) and steps 314-320 can be repeated until all of the packet capture files in the packet capture repository are processed.

Finally, at step 322, alert validator 206 or some other component of IDS test tool 200 can output a report summarizing the outcome of the test embodied by the previous steps. This report can include, e.g., a list of signatures in signature set 110 that were correctly matched by signature-based IDS 102 in response to the replays of their corresponding packet capture files, a list of signatures that were not correctly matched (which means that no alert was generated when its packet capture file was replayed), and a list of signatures whose packet capture file replay resulted in multiple alerts (which indicates that those signatures overlap with other signatures).

With the approach shown in FIG. 3 and described above, a number of advantages are realized over traditional IDS testing methodologies. First, because the packet capture data used to test signature-based IDS 102 is derived from the IDS's own signature set 110, this approach provides complete testing coverage for all of the signatures in the set.

Second, because IDS test tool 200 knows the mappings between the packet capture files and the signatures from which they are created, this approach allows for verification that the correct alert is generated in response to each packet capture file replay (rather than simply verifying that some alert is generated), as well as detection of false positive alerts.

Third, this approach enables efficient, incremental testing of signature set 110. For example, for an initial testing run, IDS test tool 200 can iterate over all of the signatures in signature set 110 as shown in flowchart 300. However, for subsequent testing runs, IDS test tool 200 may skip steps 302-312 (i.e., signature parsing/interpretation and packet capture file creation) for existing signatures; instead, tool 200 can perform these steps solely on new signatures that have been added to signature set 110 since the previous run.

Fourth, IDS test tool 200 is not restricted to testing signatures for attacks identified by third parties, and thus can be used to validate custom signatures created by, e.g., the administrators of trusted computer network 104.

The remainder of this disclosure provide additional details regarding the operation of signature interpreter 202 of IDS test tool 200 according to various embodiments. It should be appreciated that FIGS. 1-3 are illustrative and not intended to limit embodiments of the present disclosure. For example, although IDS test tool 200 is shown as being separate from signature-based IDS 102 in FIG. 2, in some embodiments IDS test tool 200 may be integrated into signature-based IDS 102. Further, although FIG. 2 depicts a particular arrangement of components within IDS test tool 200, other arrangements are possible (e.g., the functionality attributed to a particular component may be split into multiple components, components may be combined, etc.). One of ordinary skill in the art will recognize other variations, modifications, and alternatives.

### 3. Signature Interpreter Workflow

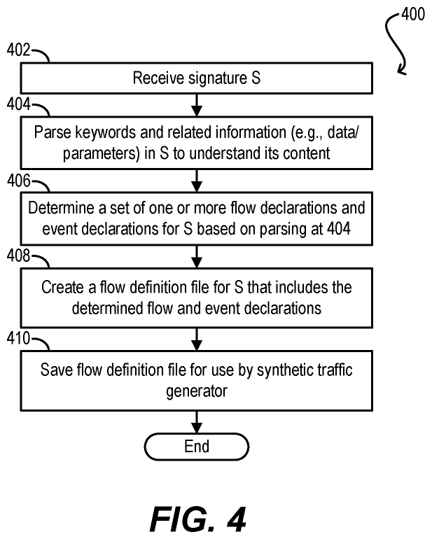

FIG. 4 depicts a flowchart 400 that elaborates on the processing that may be performed by signature interpreter 202 of IDS test tool 200 for interpreting a given signature S (per steps 304 and 306 of FIG. 3) according to certain embodiments.

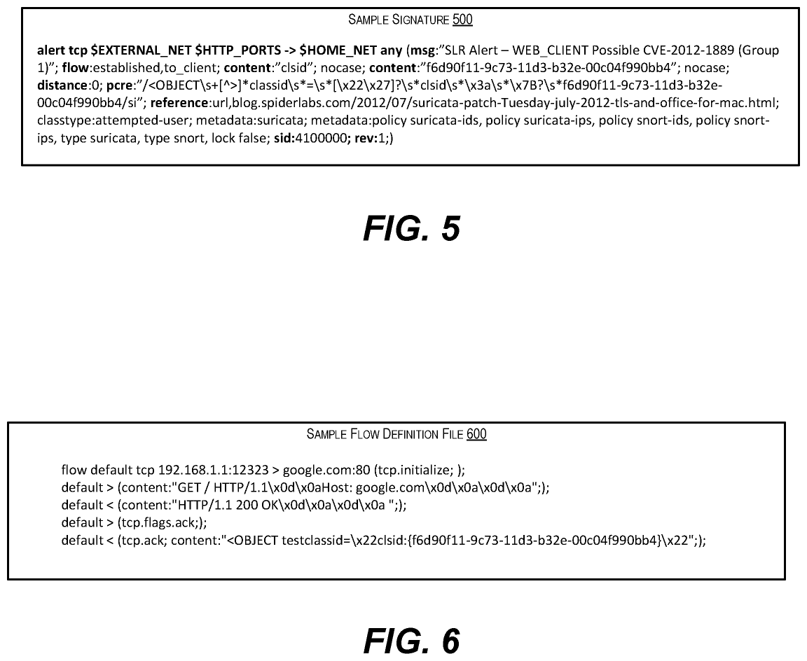

Starting with steps 402 and 404, signature interpreter 202 can receive signature S and parse keywords and related information in S to understand the signature's content (e.g., the attack to which S corresponds and the network flow(s) representative of that attack). By way of example, FIG. 5 depicts a sample signature 500 that is formatted according to the known “Suricata” signature format. As shown in FIG. 5, signature 500 comprises a number of keywords (depicted in bold) along with corresponding data/parameters. The first keyword “alert” indicates the type of action to trigger when signature 500 is matched to network traffic (i.e., generate an alert containing the message following the “msg” keyword). Other actions that may be taken in addition to generating an alert include, e.g., dropping the matched packet(s).

The second keyword in signature 500 indicates the network protocol type to be matched (“tcp” in this case), and the “flow” keyword with parameters “established,to_client” indicates that an TCP connection should be established with a flow from server to client. The permissible network addresses of the server and client are identified by the $EXTERNAL_NET and $HOME_NET variables, which may be configured within the settings of signature-based IDS 102.

The “content” keyword identifies the data that signature-based IDS 102 will look for in network packets in order to match signature 500. There may be multiple content keywords in a signature, as in this example. The “distance” keyword identifies how the second instance of the content keyword relates to the first instance. For example, a distance of 0 means that the second content should be at a zero byte distance from the first content.

The “reference” keyword identifies locations where information about signature 500 and the attack the signature corresponds to can be found. The “sid” and “rev” keywords identify the signature ID of the signature and the revision of the signature respectively.

And the “pcre” keyword is similar to the content keyword in that it identifies data that needs to be matched for the signature, but this keyword specifically contains a Perl compatible regular expression (PCRE). In Suricata, this PCRE is checked against a given network packet if and only if all of the content keywords are matched to the packet.

Returning now to flowchart 400, at steps 406 and 408, signature interpreter 202 can determine a set of one or more flow declarations and event declarations for signature S based on the parsing performed at step 404 and can create a flow definition file that includes the determined flow/event declarations. Each flow declaration can be understood as a definition of a network flow (e.g., a TCP flow) that is included in the signature and can comprise a source network address, a source port, a destination network address, a destination port, and a protocol type. Each event declaration can be understood as a definition of one or more network packets to be matched for the signature with respect to a given flow declaration.

For example, FIG. 6 depicts a sample flow definition file 600 that may be created by signature interpreter 202 for sample signature 500 of FIG. 5. In this case the flow definition file uses the syntax language supported by Flowsynth. As shown in FIG. 6, a network flow named “default” is declared in the first line, which uses the TCP protocol and identifies source and destination addresses/ports. The subsequent lines in file 600 are event declarations for the “default” flow declaration that are consistent with the signature content of sample signature 500. For instance, the last event declaration contains the content data “clsid” and “f6d9 . . . ” mentioned in signature 500.

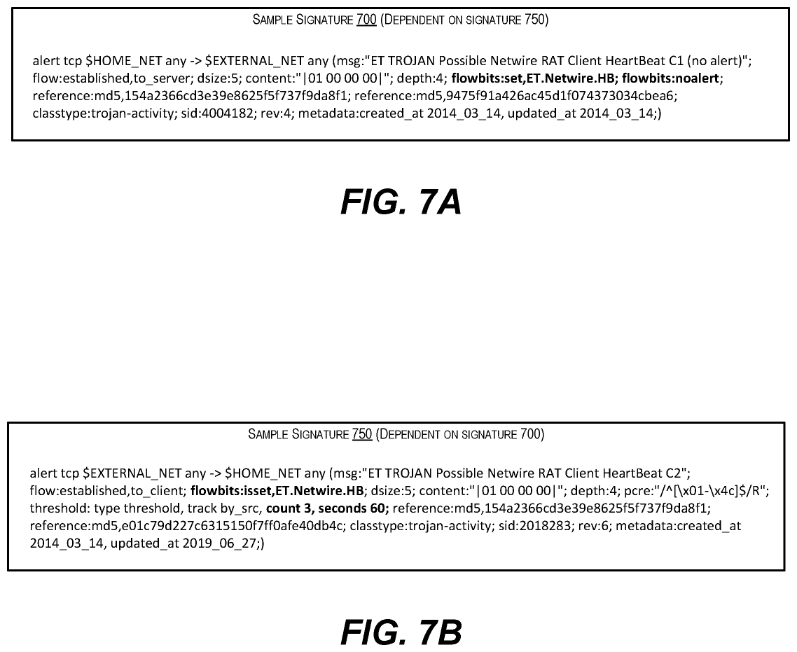

In certain embodiments, as part of the processing at steps 406 and 408 of flowchart 400, signature interpreter 202 can handle signatures that are dependent on other signatures to detect an attack. For example, assume signature S corresponds to sample signature 700 depicted in FIG. 7A, which is in turn dependent on sample signature 750 depicted in FIG. 7B. As shown in FIG. 7A, signature 700 (identified by sid 4004182) contains two instances of a “flowbits” keyword with parameters “set,ET.Netwire.HB” and “noalert.” This means that when signature-based IDS 102 matches signature 700 to a network packet, the IDS should set flowbit (i.e., variable) ET.Netwire.HB and refrain from generating an alert. Further, as shown in FIG. 7B, signature 750 (identified by sid 2018283) contains an instance of the “flowbits” keyword with parameter “isset,ET.Netwire.HB.” This means that in order for signature-based IDS 102 to trigger the alert for signature 750, the ET.Netwire.HB flowbit must be set (and thus the IDS must have matched signature 700 in the same flow first, thereby creating a dependency between the two signatures).

In this type of scenario, signature interpreter 202 can create a flow definition file that includes event declarations for both of these signatures (with the event declarations for signature 700 appearing first), thereby capturing the dependency between them. Other interesting keywords to note in signature 750 are “count: 3” and “seconds: 60,” which indicate that a matching network packet should be received at the client for a minimum of three times in the last 60 seconds in order for the signature's alert to be triggered. While parsing these keywords, signature interpreter 202 can ensure that the event declaration for signature 750 is repeated in the flow definition file three times.

Finally, at step 410, signature interpreter 202 can save the created flow definition file for use by synthetic traffic generator 204 and the flowchart can end.

Certain embodiments described herein can employ various computer-implemented operations involving data stored in computer systems. For example, these operations can require physical manipulation of physical quantities-usually, though not necessarily, these quantities take the form of electrical or magnetic signals, where they (or representations of them) are capable of being stored, transferred, combined, compared, or otherwise manipulated. Such manipulations are often referred to in terms such as producing, identifying, determining, comparing, etc. Any operations described herein that form part of one or more embodiments can be useful machine operations.

Further, one or more embodiments can relate to a device or an apparatus for performing the foregoing operations. The apparatus can be specially constructed for specific required purposes, or it can be a generic computer system comprising one or more general purpose processors (e.g., Intel or AMD x86 processors) selectively activated or configured by program code stored in the computer system. In particular, various generic computer systems may be used with computer programs written in accordance with the teachings herein, or it may be more convenient to construct a more specialized apparatus to perform the required operations. The various embodiments described herein can be practiced with other computer system configurations including handheld devices, microprocessor systems, microprocessor-based or programmable consumer electronics, minicomputers, mainframe computers, and the like.

Yet further, one or more embodiments can be implemented as one or more computer programs or as one or more computer program modules embodied in one or more non-transitory computer readable storage media. The term non-transitory computer readable storage medium refers to any storage device, based on any existing or subsequently developed technology, that can store data and/or computer programs in a non-transitory state for access by a computer system. Examples of non-transitory computer readable media include a hard drive, network attached storage (NAS), read-only memory, random-access memory, flash-based nonvolatile memory (e.g., a flash memory card or a solid state disk), persistent memory, NVMe device, a CD (Compact Disc) (e.g., CD-ROM, CD-R, CD-RW, etc.), a DVD (Digital Versatile Disc), a magnetic tape, and other optical and non-optical data storage devices. The non-transitory computer readable media can also be distributed over a network coupled computer system so that the computer readable code is stored and executed in a distributed fashion.

Finally, boundaries between various components, operations, and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations can be implemented as a combined structure or component. Similarly, structures and functionality presented as a single component can be implemented as separate components.

As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. These examples and embodiments should not be deemed to be the only embodiments and are presented to illustrate the flexibility and advantages of particular embodiments as defined by the following claims. Other arrangements, embodiments, implementations, and equivalents can be employed without departing from the scope hereof as defined by the claims.

What is claimed is:

1. A method comprising:
receiving, by a computer system, a signature from a signature set of a signature-based intrusion detection system (IDS), the signature including a pattern of network traffic;
parsing, by the computer system, the signature to understand the pattern;
creating, by the computer system, a packet capture file for the signature based on the parsing, the packet capture file including information regarding one or more network packets that conform to the pattern;
replaying, by the computer system, the packet capture file against the signature-based IDS; and
monitoring, by the computer system, the signature-based IDS during while the packet capture file is replayed to determine whether the signature-based IDS generates an alert corresponding to the signature.

2. The method of claim 1 wherein the parsing comprises:
parsing keywords and related parameters in the signature that are indicative of one or more network flows; and
determining, based on the parsing of the keywords and related parameters, one or more flow declarations and event declarations pertaining to the one or more network flows.

3. The method of claim 2 wherein the creating of the packet capture file comprises:
creating a flow definition file that includes the one or more flow declarations and event declarations; and
converting the flow definition file into the packet capture file.

4. The method of claim 1 wherein the signature is defined by a third-party security researcher or signature set vendor, and wherein the pattern of network traffic in the signature corresponds to a network attack.

5. The method of claim 1 wherein the signature is defined by an administrator of a network where the signature-based IDS is deployed, and wherein the pattern of network traffic in the signature corresponds to a pattern that is of interest to the administrator.

6. The method of claim 1 wherein the monitoring further enables the computer system to determine whether one or more false positive alerts are generated in response to the replay of the packet capture file.

7. The method of claim 1 wherein the signature includes dependencies with respect to one or more other signatures in the signature set, and wherein the information included in the packet capture file incorporates the dependencies.

8. A non-transitory computer readable storage medium having stored thereon program code executable by a computer system, the program code causing the computer system to:
receive a signature from a signature set of a signature-based intrusion detection system (IDS), the signature including a pattern of network traffic;
parse the signature to understand the pattern;
create a packet capture file for the signature based on the parsing, the packet capture file including information regarding one or more network packets that conform to the pattern;
replay the packet capture file against the signature-based IDS; and
monitor the signature-based IDS during while the packet capture file is replayed to determine whether the signature-based IDS generates an alert corresponding to the signature.

9. The non-transitory computer readable storage medium of claim 8 wherein the parsing comprises:
parsing keywords and related parameters in the signature that are indicative of one or more network flows; and
determining, based on the parsing of the keywords and related parameters, one or more flow declarations and event declarations pertaining to the one or more network flows.

10. The non-transitory computer readable storage medium of claim 9 wherein the creating of the packet capture file comprises:
creating a flow definition file that includes the one or more flow declarations and event declarations; and
converting the flow definition file into the packet capture file.

11. The non-transitory computer readable storage medium of claim 8 wherein the signature is defined by a third-party security researcher or signature set vendor, and wherein the pattern of network traffic in the signature corresponds to a network attack.

12. The non-transitory computer readable storage medium of claim 8 wherein the signature is defined by an administrator of a network where the signature-based IDS is deployed, and wherein the pattern of network traffic in the signature corresponds to a pattern that is of interest to the administrator.

13. The non-transitory computer readable storage medium of claim 8 wherein the monitoring further enables the computer system to determine whether one or more false positive alerts are generated in response to the replay of the packet capture file.

14. The non-transitory computer readable storage medium of claim 8 wherein the signature includes dependencies with respect to one or more other signatures in the signature set, and wherein the information included in the packet capture file incorporates the dependencies.

15. A computer system comprising:
a processor; and
a non-transitory computer readable medium having stored thereon program code that, when executed by the processor, causes the processor to:
receive a signature from a signature set of a signature-based intrusion detection system (IDS), the signature including a pattern of network traffic;
parse the signature to understand the pattern;
create a packet capture file for the signature based on the parsing, the packet capture file including information regarding one or more network packets that conform to the pattern;
replay the packet capture file against the signature-based IDS; and
monitor the signature-based IDS during while the packet capture file is replayed to determine whether the signature-based IDS generates an alert corresponding to the signature.

16. The computer system of claim 15 wherein the parsing comprises:
parsing keywords and related parameters in the signature that are indicative of one or more network flows; and
determining, based on the parsing of the keywords and related parameters, one or more flow declarations and event declarations pertaining to the one or more network flows.

17. The computer system of claim 16 wherein the creating of the packet capture file comprises:
creating a flow definition file that includes the one or more flow declarations and event declarations; and
converting the flow definition file into the packet capture file.

18. The computer system of claim 15 wherein the signature is defined by a third-party security researcher or signature set vendor, and wherein the pattern of network traffic in the signature corresponds to a network attack.

19. The computer system of claim 15 wherein the signature is defined by an administrator of a network where the signature-based IDS is deployed, and wherein the pattern of network traffic in the signature corresponds to a pattern that is of interest to the administrator.

20. The computer system of claim 15 wherein the monitoring further enables the computer system to determine whether one or more false positive alerts are generated in response to the replay of the packet capture file.

21. The computer system of claim 15 wherein the signature includes dependencies with respect to one or more other signatures in the signature set, and wherein the information included in the packet capture file incorporates the dependencies.
